(19) United States
(12) Patent Application Publication
(10) Pub. No.: US 2018/0144323 A1
(43) Pub. Date: May 24, 2018

(54) SYSTEM AND METHOD FOR PROCESSING PAYMENT

(71) Applicant: MasterCard International Incorporated, Purchase, NY (US)

(72) Inventors: Navneet Jain, Pune (IN); Arunmurthy Gurunathan, Pune (IN)

(21) Appl. No.: 15/795,483

(22) Filed: Oct. 27, 2017

(30) Foreign Application Priority Data
Nov. 23, 2016 (SG) 10201609847P

(51) Int. Cl. G06Q 20/20; G06Q 20/10; G06Q 20/40; G06F 17/30

(52) U.S. Cl. CPC G06Q 20/202; G06Q 20/10; G06Q 20/4014; G06Q 20/206; G06F 17/30864; G06Q 20/4012

(57) ABSTRACT

A system for processing payment, comprising: a processor module in communication with a point-of-sale (POS) terminal and a payment module, wherein the processor module is configured to: (i) receive, from the POS terminal: a first set of characters that is a proxy for a first account number associated with a fund recipient's account; a second set of characters that is a proxy for a second account number associated with a fund sender's account; and an amount of funds requested by the fund recipient from the fund sender for payment; (ii) convert: the first set of characters into the first account number; the second set of characters into the second account number; and (iii) transmit, to the payment module: the first and second account numbers; and an instruction to deduct the amount of funds requested by the fund recipient from the fund sender's account that is associated with the second account number.

### CROSS-REFERENCE TO RELATED APPLICATION

This application is a U.S. National Stage filing under 35 U.S.C. § 119, based on and claiming benefit of and priority to SG Patent Application No. 10201609847P filed Nov. 23, 2016.

### FIELD OF INVENTION

The present invention relates broadly, but not exclusively, to systems and methods for processing payment.

### BACKGROUND

Currently, peer-to-peer fund transfer can be performed by using a bank's online banking website. Typically, a user logs-in to the online banking website and enters the fund recipient's bank name, account number and amount of funds to be transferred.

However, some users might not be comfortable giving out their bank account numbers. There are also others who find it hard to remember their bank account numbers, let alone a recipient's bank account number.

There are mobile applications that allow users to use their mobile phone numbers to perform fund transfers instead of having to input bank account numbers. For example, in Singapore, DBS Bank Ltd has a PayLah! mobile application that allows user to perform fund transfers without the need to know the bank account number of recipients. The PayLah! mobile application acts as a mobile wallet that is linked with a user's mobile phone number and DBS bank account. The mobile phone number becomes a unique identifier for users to send or receive funds. Both senders and recipients are required to have a PayLah! mobile application installed on their mobile phones.

The State Bank of India has a similar service, which is known as Immediate Payment Service (IMPS). IMPS is an instant interbank electronic fund transfer service through mobile phones and is also being extended through other channels such as ATM, Internet Banking, etc. To initiate fund transfers using IMPS, a Mobile Money Identification Number (MMID) is required. The MMID is a seven digit number of which the first four digits are the unique identification number of the bank offering IMPS.

Both PayLah! and IMPS function like stored value payment cards in that a user has to reload or top-up their account when the funds in the account run out. Currently, if a user goes shopping and runs out of cash or reaches the credit limit of his/her credit card, he/she cannot use peer-to-peer fund transfer services such as PayLah! and IMPS to make payment at a merchant's point-of-sale (POS) terminal.

A need therefore exists to provide methods and/or systems for processing payment that seek to address at least some of the above problems.

### SUMMARY

According to a first aspect, there is provided a system for processing payment, comprising: a processor module in communication with a point-of-sale (POS) terminal and a payment module, wherein the processor module is configured to: (i) receive, from the POS terminal: a first set of characters that is a proxy for a first account number associated with a fund recipient's account; a second set of characters that is a proxy for a second account number associated with a fund sender's account; and an amount of funds requested by the fund recipient from the fund sender for payment; (ii) convert: the first set of characters into the first account number; the second set of characters into the second account number; and (iii) transmit, to the payment module: the first and second account numbers; and an instruction to deduct the amount of funds requested by the fund recipient from the fund sender's account that is associated with the second account number.

According to a second aspect, there is provided a method of processing payment, comprising: (a) receiving, at a processor module from a point-of-sale (POS) terminal: a first set of characters that is a proxy for a first account number associated with a fund recipient's account; a second set of characters that is a proxy for a second account number associated with a fund sender's account; and an amount of funds requested by the fund recipient from the fund sender; (b) converting, by the processor module: the first set of characters into the first account number; the second set of characters into the second account number; and (c) transmitting, from the processor module to a payment module: the first and second account numbers; and an instruction to deduct the amount of funds requested by the fund recipient from the fund sender's account that is associated with the second account number.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 is a schematic of a system for processing payment, according to an embodiment, according to an example embodiment;

FIG. 2 is a flowchart illustrating a method for processing payment, according to an example embodiment;

FIG. 3 is a schematic diagram illustrating flow of information between various entities involved in a method of processing payment, according to an example embodiment;

FIG. 4 is a schematic diagram illustrating flow of information between various entities during a registration phase of a method of processing payment, according to an example embodiment;

FIG. 5 is a schematic diagram illustrating flow of information between various entities during a fund transfer phase of a method of processing payment, according to an example embodiment;

FIG. 6 is a schematic diagram illustrating flow of information between various entities during a fund transfer phase of a method of processing payment, according to an example embodiment; and

FIG. 7 shows a schematic diagram of a computer system suitable for use in executing at least some steps of the method for processing payment and/or for realizing at least a part of the system for processing payment.

### DETAILED DESCRIPTION

Embodiments will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer suitable for executing the various methods/processes described herein will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

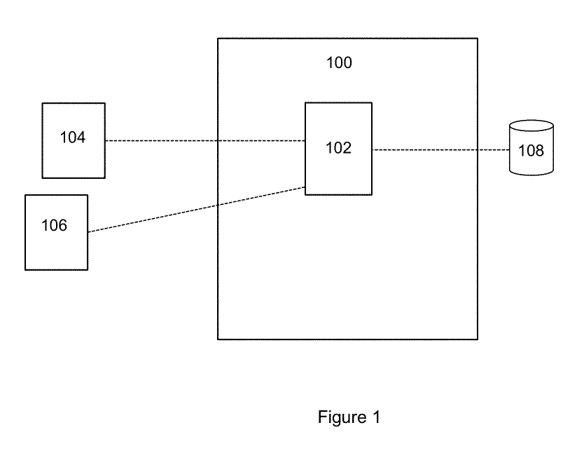

FIG. 1 is a schematic of a system 100 for processing payment, according to an embodiment. The system 100 can be used, for example, for processing payment for one or more products. Where the context permits, singular (e.g. “product”) or plural terms may also include the plural (e.g. “products”) or singular term, respectively. The system 100 comprises a processor module 102 in communication with a point-of-sale (POS) terminal 104 and a payment module 106.

In the following description, the term “module” (e.g. processor module, payment module, etc.) can refer to software, a hardware element, or a combination of both.

The processor module 102 is configured to receive, from the POS terminal 104: (i) a first set of characters (e.g. numbers, alphabets or a combination of both) that is a proxy for a first account number associated with a fund recipient's account; (ii) a second set of characters (e.g. numbers, alphabets or a combination of both) that is a proxy for a second account number associated with a fund sender's account; and (iii) an amount of funds requested by the fund recipient from the fund sender for payment (e.g. payment for the one or more products).

The first and second set of characters may be a unique set of characters that are used as a proxy or substitute for the first and second account numbers, respectively. For example, the first and second set of characters may be mobile phone numbers or Mobile Money Identification Numbers (MMIDs) related to the fund recipient and fund sender, respectively.

The first and second set of characters are received at the processor module 102 from the POS terminal 104 in a format according to ISO 8583 data element 2. The POS terminal 104 may be configured to append at least one digit to the first and second set of characters such that the first and second set of characters are received at the processor module 102 in the format according to ISO 8583 data element 2.

The processor module 102 is further configured to convert the first set of characters into the first account number, and the second set of characters into the second account number. The processor module 102 may be in further communication with a database 108. In FIG. 1, the database 108 is shown as an external module. However, the database 108 can be an internal module (i.e. part of the system 100) or implemented as a cloud computing storage module. In one implementation, to convert the first and second set of characters into the first and second account numbers, respectively, the processor module 102 can be further configured to: (i) retrieve, from the database 108, the first account number that is linked to the first set of characters in the database; (ii) retrieve, from the database 108, the second account number that is linked to the second set of characters in the database; and (iii) substitute the first and second set of characters with the retrieved first and second account numbers, respectively.

The processor module 102 is further configured to transmit, to the payment module 106: the first and second account numbers; and an instruction to deduct the amount of funds requested by the fund recipient from the fund sender's account that is associated with the second account number. The first and second account numbers are preferably transmitted from the processor module 102 to the payment module 106 in the format according to ISO 8583 data element 2.

The payment module 106 may be a server that facilitates communication between an acquiring bank associated with a merchant and an issuing bank associated with the fund sender and/or fund recipient. In an implementation, the payment module 106 may be configured to perform one or more functions of a payment gateway.

In an implementation, the processor module 102 may be further configured to transmit the instruction to deduct the amount of funds requested by the fund recipient to the payment module 106 on a condition that there is a prior approval from the fund sender for deduction of funds from the account that is associated with the second account number (i.e. the fund sender's account) upon a request by the fund recipient having the account that is associated with the first account number. In other words, the fund sender should have pre-approved the sending of funds to the particular fund recipient from his account. If another fund recipient requests for funds and has not been pre-approved by the fund sender, the deduction/transfer of funds does not take place. The identification of the fund recipient and fund sender can be based on their respective unique set of characters which are proxies for their account numbers.

The prior approval from the fund sender may comprise a pre-determined limit specified by the fund sender with respect to the maximum amount of funds that can be deducted from the account that is associated with the second account number upon the request by the fund recipient having the account that is associated with the first account number. Accordingly, the amount of funds requested by the fund recipient is deducted from the account that is associated with the second account number (i.e. the fund sender's account) on a further condition that the amount of funds requested is equal to or less than the pre-determined limit specified by the fund sender. For example, the pre-determined limit specified by the fund sender is $100. If the amount of funds requested by the fund recipient is equal to or less than $100, the deduction takes place. On the other hand, if the amount of funds requested by the fund recipient is more than $100, the deduction does not take place.

In an implementation, the processor module 102 may further configured to transmit, to the POS terminal 104, a deduction success indication upon successful deduction of the amount of funds requested by the fund recipient from the fund sender's account that is associated with the second account number.

In the examples provided above, the amount of funds requested by the fund recipient is equal to the price of the products. In other words, the fund sender fully pays for the products on behalf of the recipient. Alternatively, the recipient can partially pay for the products. Accordingly, in an implementation, if the amount of funds requested by the fund recipient from the fund sender for payment for the products is less than a price of the products, the processor module 102 can be further configured to: receive the price of the products from the POS terminal 104 (e.g. $50); and determine an amount of funds to be deducted from the fund recipient's account that is associated with the first account number based on a difference between the price of the products ($50) and the amount of funds requested by the fund recipient (e.g. $20). In this case, an amount of funds to be deducted from the fund recipient's account is $30. The processor module 102 can be further configured to transmit, to the payment module 106, an instruction to deduct the determined amount of funds from the fund recipient's account ($30) that is associated with the first account number.

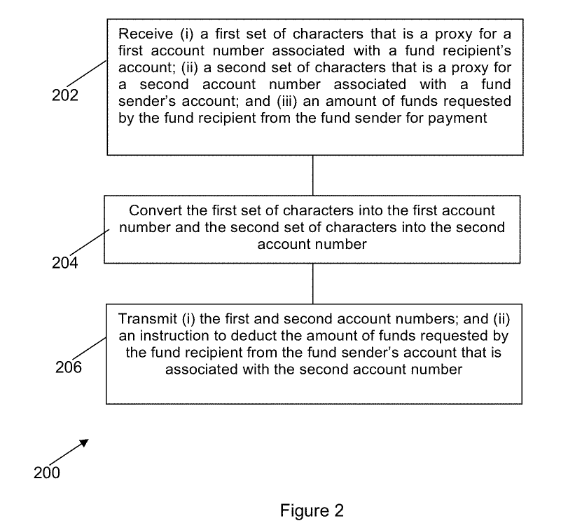

FIG. 2 is a flowchart 200 illustrating a method of processing payment (e.g. for one or more products), according to an example embodiment. At step 202, (i) a first set of characters that is a proxy for a first account number associated with a fund recipient's account; (ii) a second set of characters that is a proxy for a second account number associated with a fund sender's account; and (iii) an amount of funds requested by the fund recipient from the fund sender, are received at a processor module from a point-of-sale (POS) terminal. As mentioned above, the first and second set of characters may be a unique set of characters that are used as a proxy or substitute for the first and second account numbers, respectively. For example, the first and second set of characters may be mobile phone numbers or Mobile Money Identification Numbers (MMIDs) related to the fund recipient and fund sender, respectively. The first and second set of characters are preferably received at the processor module in a format according to ISO 8583 data element 2.

At step 204, the processor module converts the first set of characters into the first account number, and the second set of characters into the second account number. The step 204 of converting the first and second set of characters into the first and second account numbers respectively may include: (a) retrieving, from a database: (i) the first account number that is linked to the first set of characters in the database; and (ii) the second account number that is linked to the second set of characters in the database; and (b) substituting the first and second set of characters with the retrieved first and second account numbers, respectively.

At step 206, (i) the first and second account numbers, and (ii) an instruction to deduct the amount of funds requested by the fund recipient from the fund sender's account that is associated with the second account number, are transmitted from the processor module to a payment module.

The first and second account numbers are preferably transmitted from the processor module to the payment module in the format according to ISO 8583 data element 2. The method may further comprise appending at least one digit to the first and second set of characters such that the first and second set of characters are received at the processor module in the format according to ISO 8583 data element 2.

In an implementation, the instruction to deduct the amount of funds requested by the fund recipient is transmitted from the processor module to the payment module on a condition that there is a prior approval from the fund sender for deduction of funds from the account that is associated with the second account number upon a request by the fund recipient having the account that is associated with the first account number. The prior approval from the fund sender comprises a pre-determined limit specified by the fund sender with respect to the maximum amount of funds that can be deducted from the account that is associated with the second account number upon the request by the fund recipient having the account that is associated with the first account number. The amount of funds requested by the fund recipient is deducted from the account that is associated with the second account number on a further condition that the amount of funds requested is equal to or less than the pre-determined limit specified by the fund sender.

In a further implementation, the method may further comprise transmitting, from the processor module to the POS terminal, a deduction success indication upon successful deduction of the amount of funds requested by the fund recipient from the fund sender's account that is associated with the second account number.

In yet another implementation, if the amount of funds requested by the fund recipient from the fund sender for payment for the products is less than a price of the products, the method may further comprise: (i) receiving, at the processor module from the POS terminal, the price of the products; (ii) determining, by the processor module, an amount of funds to be deducted from the fund recipient's account that is associated with the first account number based on a difference between the price of the products and the amount of funds requested by the fund recipient; and (iii) transmitting, from the processor module to the payment module, an instruction to deduct the determined amount of funds from the fund recipient's account that is associated with the first account number.

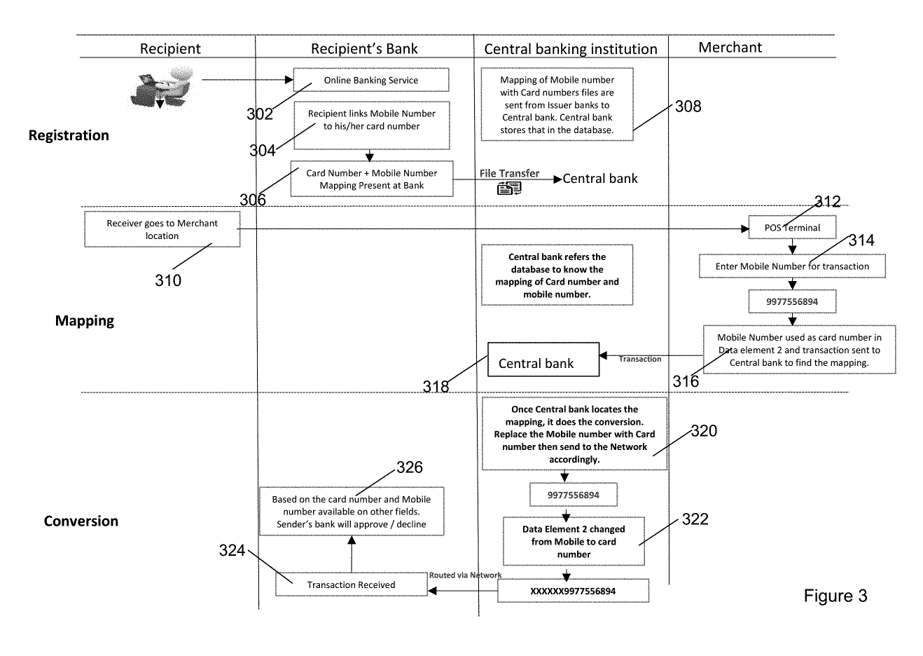

FIG. 3 is a schematic diagram illustrating flow of information between various entities involved in a method of processing payment (e.g. for one or more products). The method may comprise three main phases—a one-time registration phase, a mapping phase and a conversion phase. During the registration phase, a fund recipient (i.e. someone who wishes to receive funds) logs-in to his bank's online banking service (e.g. via a mobile application or online banking website) at step 302. At step 304, the recipient links his mobile phone number to his payment card account number. Essentially, the mobile phone number (i.e. a unique set of numbers) is mapped to the recipient's payment card account number. At step 306, the mapping is stored in a database of the recipient's bank (i.e. issuer bank). At step 308, the mapping is sent from the recipient's bank to a central bank server (e.g. Reserve Bank of India, Monetary Authority of Singapore, European Central Bank) for storage in the central bank's database. A fund sender (i.e. someone who wishes to send funds to the fund recipient) also performs the above mentioned steps 302 and 304. The fund sender's mobile phone number is also mapped to his payment card account number and the mapping is saved in the respective databases as per steps 306 and 308. Preferably, the registration phase comprising steps 302, 304, 306 and 308 is performed once.

During the mapping phase, at step 310, the recipient goes to a merchant's outlet and wishes to purchase and make payment for one or more products that are sold by the merchant. Assume that the recipient has insufficient funds to make payment for the one or more products (e.g. he/she has insufficient cash on hand, insufficient funds in his/her debit card account and/or has reached his/her credit card account limit). At step 312, the recipient goes to the merchant's POS terminal. The recipient enters the sender's registered mobile phone number at the POS terminal (e.g. using the keypad of the POS terminal) at step 314. Assume the sender's mobile phone number is “9977556894”. At step 316, the sender's mobile phone number is used as a proxy for a payment card number (e.g. in a format according to data element 2 of ISO 8583).

If necessary, one or more digits may be appended to the mobile phone number so that the mobile phone number is in the proper format. For example, data element 2 of ISO 8583 is a primary account number (PAN), and the PAN may consist of 16 digits. The digits “100000” can be appended before “9977556894” to form a 16 digit proxy for the PAN (i.e. “1000009977556894”). One or more of the appended digits (e.g. the first digit “1”) can be used as a flag to indicate that this is a proxy PAN and not a “real” PAN.

Step 316 further involves transmitting the mobile phone number (i.e. proxy PAN) to the central bank. At step 318, the central bank's server accesses its database and locates the actual PAN that is linked/mapped to the mobile phone number.

The next phase, the conversion phase, begins at step 320 where the mobile phone number is replaced or substituted with the actual PAN that is linked to the mobile phone number in the central bank's database. In particular, at step 322, data element 2 of ISO 8583 is changed from the mobile phone number to the actual PAN. The data element 2/actual PAN is sent to a payment module/gateway for normal processing as known in the art. For example, at step 324, the transaction details are received. At step 326, the recipient's bank approves or declines the transaction based on the (i) received transaction details, (ii) received PAN and optionally, (iii) mobile phone number of the recipient and/or sender.

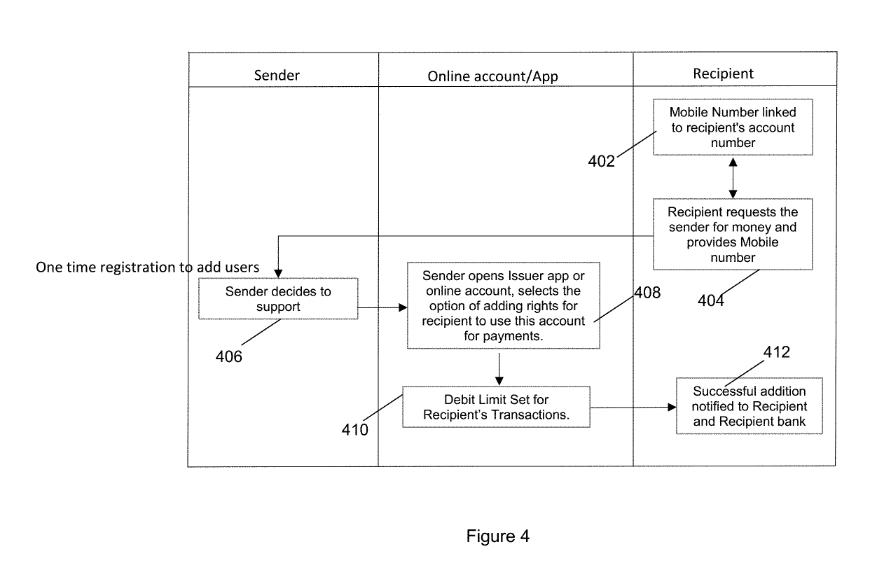

FIG. 4 is a schematic diagram illustrating flow of information between various entities during a registration phase of a method of processing payment (e.g. for one or more products). At step 402, a recipient's mobile phone number is linked to his account number. At step 404, assume that the recipient has insufficient funds make payment for the one or more products and therefore requests funds from a sender by providing the sender's mobile phone number (e.g. at a merchant's POS terminal).

At step 406, the sender can choose whether to support or decline the request for funds from the particular recipient. One sender can support more than one recipient; and one recipient can be supported by more than one sender. Assume that the sender chooses to support the request from the particular recipient. At step 408, the sender opens his mobile application or online banking website and selects an option of adding rights for the particular recipient to use the sender's account for future payments (i.e. to receive funds).

Optionally, at step 410, the sender can determine a limit for an amount of funds to be received by the recipient. Alternative or additionally, there can be an option for the sender to approve each and every fund transfer to the recipient before funds are sent to the recipient. At step 412, the recipient and his bank are notified if the sender has decided to support the recipient's future fund requests.

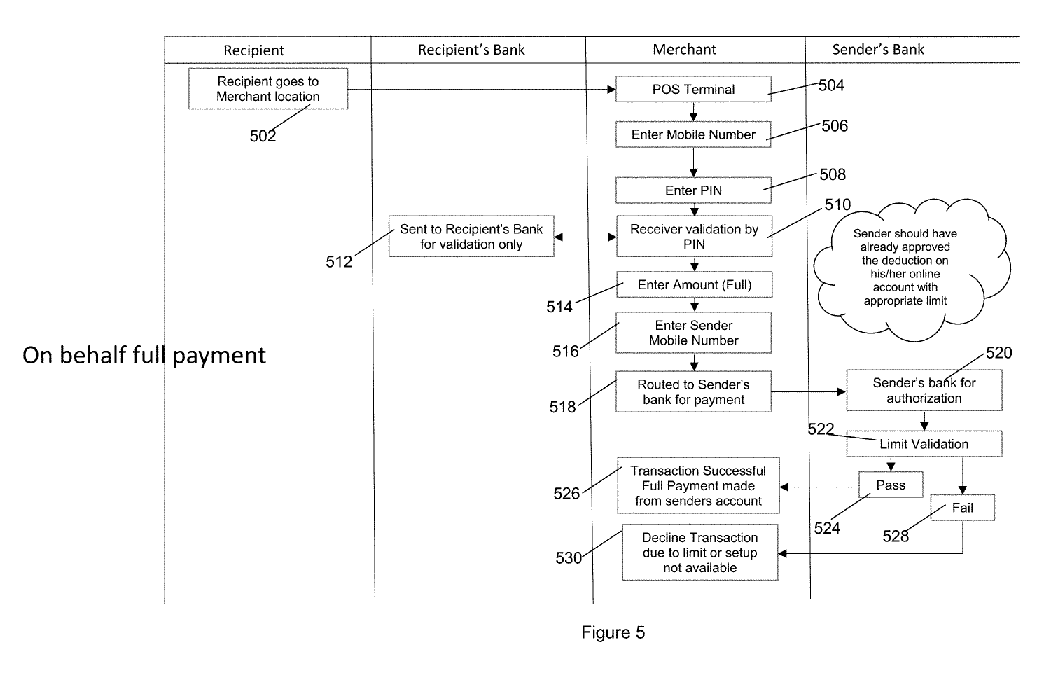

FIG. 5 is a schematic diagram illustrating flow of information between various entities during a fund transfer phase of a method of processing payment (e.g. for one or more products). It is assumed that the fund sender has already approved fund transfers to the fund recipient, for example based on the above described registration steps. At step 502, the recipient goes to a merchant's outlet and wishes to purchase and make payment for one or more products that are sold by the merchant. Assume that the recipient has insufficient funds to make payment for the one or more products (e.g. he/she has insufficient cash on hand, insufficient funds in his/her debit card account and/or has reached his/her credit card account limit).

At step 504, the recipient goes to the merchant's POS terminal. The recipient enters his mobile phone number at the POS terminal (e.g. using the keypad of the POS terminal) at step 506. Optionally, for added security, the recipient enters his personal identification number (PIN) for authentication purposes at step 508. At step 510, the PIN is validated. For example, the PIN can be validated by the recipient's bank at step 512. At step 514, it is assumed that the recipient requests that the sender provide funds to make full payment for the entire purchase (i.e. funds equal to the total price of the one or more products that the fund recipient wishes to purchase). This option for “full payment” may be inputted by the recipient.

At step 516, the recipient enters the fund sender's mobile phone number. Thereafter, the product payment request is routed to the sender's bank at step 518. At step 520, the sender's bank performs the necessary authorization checks. If the fund sender has previously set a limit of funds to be sent to the fund recipient, a check is performed at step 522. If, at step 524, the requested amount of funds does not exceed the pre-determined limit, the transaction is successful and full payment for the product(s) is made from the sender's account (step 526). On the other hand, at step 528, if the requested amount of funds exceeds the pre-determined limit, or the fund sender has not pre-authorized fund transfers to the fund recipient, the transaction is declined (step 530).

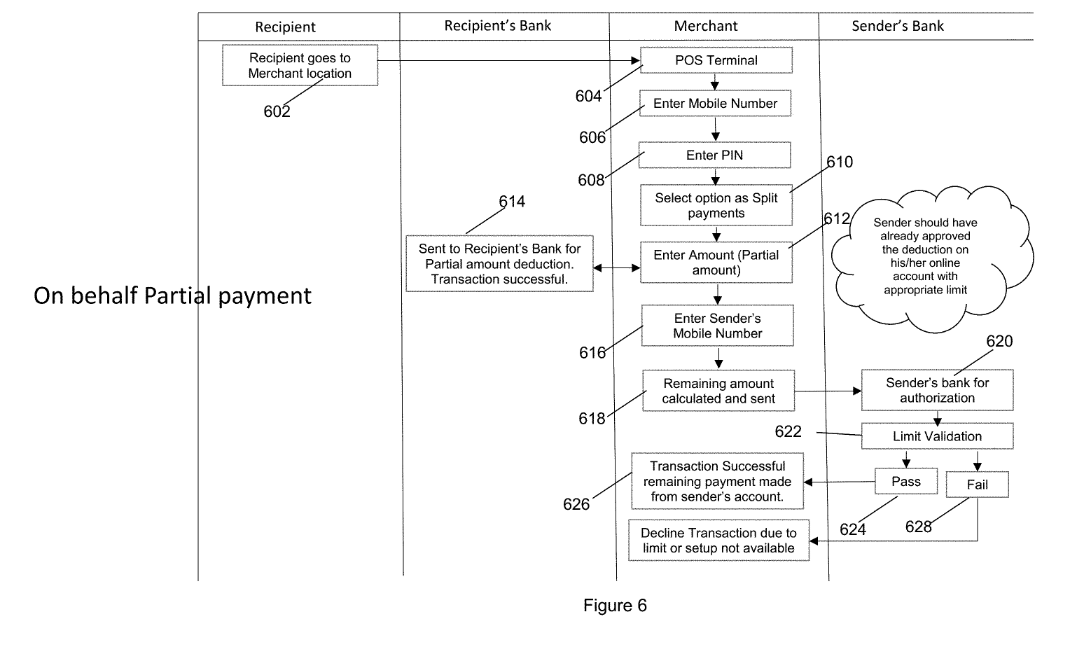

FIG. 6 is a schematic diagram illustrating flow of information between various entities during a fund transfer phase of a method of processing payment (e.g. for one or more products). It is assumed that the fund sender has already approved fund transfers to the fund recipient, for example based on the above described registration steps. At step 602, the recipient goes to a merchant's outlet and wishes to purchase and make payment for one or more products that are sold by the merchant. Assume that the recipient has insufficient funds to make payment for the one or more products (e.g. he/she has insufficient cash on hand, insufficient funds in his/her debit card account and/or has reached his/her credit card account limit).

At step 604, the recipient goes to the merchant's POS terminal. The recipient enters his mobile phone number at the POS terminal (e.g. using the keypad of the POS terminal) at step 606. Optionally, for added security, the recipient enters his personal identification number (PIN) for authentication purposes at step 608. At step 610, it is assumed that the recipient requests that the sender provide partial funds to make payment for the purchase (i.e. funds that are less than the total price of the one or more products that the fund recipient wishes to purchase). Alternatively, the fund recipient can input the amount of funds that he/she will be contributing for payment of the one of more products. This option for “partial payment” may be inputted by the recipient. At step 612, the recipient enters the amount of funds that he/she will be contributing for payment of the one of more products. At step 614, the amount of funds that he/she will be contributing for payment of the one of more products is sent to the recipient's bank for deduction from the recipient's bank account.

At step 616, the recipient enters the fund sender's mobile phone number. At step 618, the remaining amount (i.e. the difference between the total price of the one or more products and the amount of funds contributed by the sender) is calculated and routed to the sender's bank. The sender's bank authorizes the product payment request/transaction request at step 620. If the fund sender has previously set a limit of funds to be sent to the fund recipient, a check is performed at step 622. If, at step 624, the requested amount of funds does not exceed the pre-determined limit, the transaction is successful and partial payment for the product(s) is made from the sender's account (step 626). On the other hand, at step 628, if the requested amount of funds exceeds the pre-determined limit, or the fund sender has not pre-authorized fund transfers to the fund recipient, the transaction is declined (step 630).

The above-described embodiments provide several advantages. Firstly, a “no supervision” model is provided whereby the fund sender does not need to be physically at a merchant's POS terminal to approve the fund transfer to the fund recipient. The fund sender simply pre-approves fund transfers to the fund recipient and optionally specifies a transfer limit (one-time or cumulative over a period of time). Secondly, fund recipients can choose to have full or partial payment of products by the fund sender. Thirdly, compared to bank account numbers, a relatively less sensitive set of characters/numbers are used to initiate the fund transfer. In the case of mobile phone numbers, it is relatively easier for users to remember compared to bank account numbers.

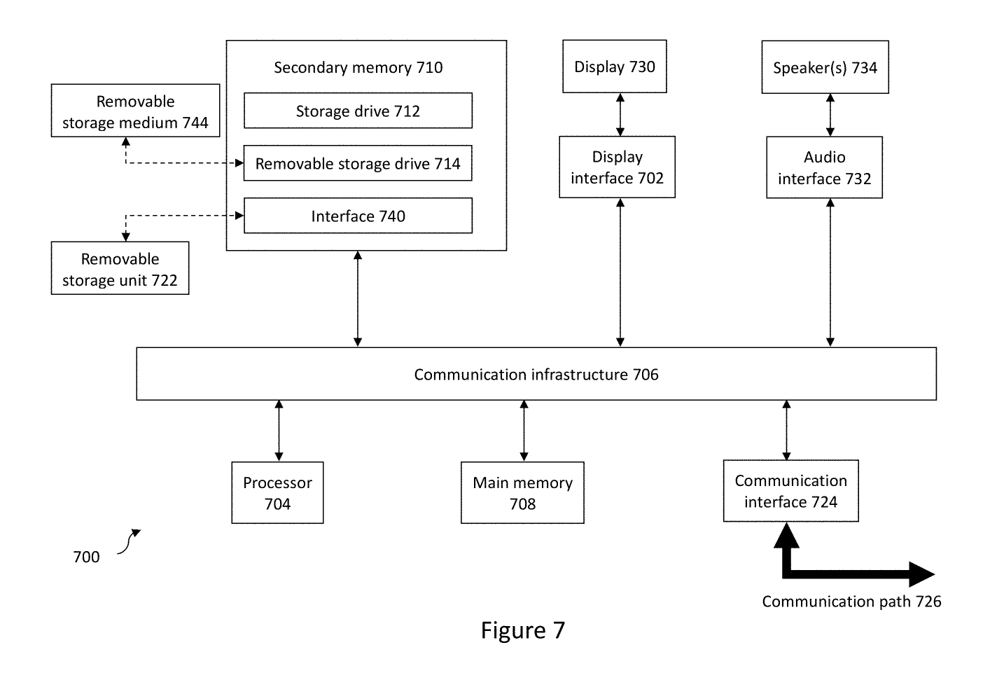

FIG. 7 shows a schematic diagram of a computer device/system 700 suitable for use in executing at least some steps of the method for processing payment and/or for realizing at least a part of the system 100 for processing payment. The following description of the computing device 700 is provided by way of example only and is not intended to be limiting.

As shown in FIG. 7, the example computing device 700 includes a processor 704 for executing software routines. Although a single processor is shown for the sake of clarity, the computing device 700 may also include a multi-processor system. The processor 704 is connected to a communication infrastructure 706 for communication with other components of the computing device 700. The communication infrastructure 706 may include, for example, a communications bus, cross-bar, or network.

The computing device 700 further includes a main memory 708, such as a random access memory (RAM), and a secondary memory 710. The secondary memory 710 may include, for example, a hard disk drive 712 and/or a removable storage drive 714, which may include a magnetic tape drive, an optical disk drive, or the like. The removable storage drive 714 reads from and/or writes to a removable storage unit 718 in a well-known manner. The removable storage unit 718 may include a magnetic tape, optical disk, or the like, which is read by and written to by removable storage drive 714. As will be appreciated by persons skilled in the relevant art(s), the removable storage unit 718 includes a computer readable storage medium having stored therein computer executable program code instructions and/or data.

In an alternative implementation, the secondary memory 710 may additionally or alternatively include other similar means for allowing computer programs or other instructions to be loaded into the computing device 700. Such means can include, for example, a removable storage unit 722 and an interface 720. Examples of a removable storage unit 722 and interface 720 include a removable memory chip (such as an EPROM or PROM) and associated socket, and other removable storage units 722 and interfaces 720 which allow software and data to be transferred from the removable storage unit 722 to the computer system 700.

The computing device 700 also includes at least one communication interface 724. The communication interface 724 allows software and data to be transferred between computing device 700 and external devices via a communication path 726. In various embodiments, the communication interface 724 permits data to be transferred between the computing device 700 and a data communication network, such as a public data or private data communication network. The communication interface 724 may be used to exchange data between different computing devices 700 which such computing devices 700 form part an interconnected computer network. Examples of a communication interface 724 can include a modem, a network interface (such as an Ethernet card), a communication port, an antenna with associated circuitry and the like. The communication interface 724 may be wired or may be wireless. Software and data transferred via the communication interface 724 are in the form of signals which can be electronic, electromagnetic, optical or other signals capable of being received by communication interface 724. These signals are provided to the communication interface via the communication path 726.

Optionally, the computing device 700 further includes a display interface 702 which performs operations for rendering images to an associated display 730 and an audio interface 732 for performing operations for playing audio content via associated speaker(s) 734.

As used herein, the term “computer program product” may refer, in part, to removable storage unit 718, removable storage unit 722, a hard disk installed in hard disk drive 712, or a carrier wave carrying software over communication path 726 (wireless link or cable) to communication interface 724. Computer readable storage media refers to any non-transitory tangible storage medium that provides recorded instructions and/or data to the computing device 700 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computing device 700. Examples of transitory or non-tangible computer readable transmission media that may also participate in the provision of software, application programs, instructions and/or data to the computing device 700 include radio or infra-red transmission channels as well as a network connection to another computer or networked device, and the Internet or Intranets including e-mail transmissions and information recorded on Websites and the like.

The computer programs (also called computer program code) are stored in main memory 708 and/or secondary memory 710. Computer programs can also be received via the communication interface 724. Such computer programs, when executed, enable the computing device 700 to perform one or more features of embodiments discussed herein. In various embodiments, the computer programs, when executed, enable the processor 704 to perform features of the above-described embodiments. Accordingly, such computer programs represent controllers of the computer system 700.

Software may be stored in a computer program product and loaded into the computing device 700 using the removable storage drive 714, the hard disk drive 712, or the interface 720. Alternatively, the computer program product may be downloaded to the computer system 700 over the communications path 726. The software, when executed by the processor 704, causes the computing device 700 to perform functions of embodiments described herein.

It is to be understood that the embodiment of FIG. 7 is presented merely by way of example. Therefore, in some embodiments one or more features of the computing device 700 may be omitted. Also, in some embodiments, one or more features of the computing device 700 may be combined together. Additionally, in some embodiments, one or more features of the computing device 700 may be split into one or more component parts.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A system for processing payment, comprising:
a processor module in communication with a point-of-sale (POS) terminal and a payment module, wherein the processor module is configured to:
receive, from the POS terminal:
a first set of characters that is a proxy for a first account number associated with a fund recipient's account;
a second set of characters that is a proxy for a second account number associated with a fund sender's account; and
an amount of funds requested by the fund recipient from the fund sender for payment;
convert:
the first set of characters into the first account number;
the second set of characters into the second account number; and
transmit, to the payment module:
the first and second account numbers; and
an instruction to deduct the amount of funds requested by the fund recipient from the fund sender's account that is associated with the second account number.

2. The system as claimed in claim 1, wherein the first and second set of characters are received at the processor module in a format according to ISO 8583 data element 2.

3. The system as claimed in claim 2, wherein the processor module is in further communication with a database and the processor module is further configured to:
retrieve, from the database, the first account number that is linked to the first set of characters in the database;
retrieve, from the database, the second account number that is linked to the second set of characters in the database; and
substitute the first and second set of characters with the retrieved first and second account numbers respectively, wherein the first and second account numbers are transmitted from the processor module to the payment module in the format according to ISO 8583 data element 2.

4. The system as claimed in claim 2, wherein the POS terminal is configured to append at least one digit to the first and second set of characters such that the first and second set of characters are received at the processor module in the format according to ISO 8583 data element 2.

5. The system as claimed in claim 1, wherein the processor module is further configured to transmit the instruction to deduct the amount of funds requested by the fund recipient to the payment module on a condition that there is a prior approval from the fund sender for deduction of funds from the account that is associated with the second account number upon a request by the fund recipient having the account that is associated with the first account number.

6. The system as claimed in claim 5, wherein the prior approval from the fund sender comprises a pre-determined limit specified by the fund sender with respect to the maximum amount of funds that can be deducted from the account that is associated with the second account number upon the request by the fund recipient having the account that is associated with the first account number.

7. The system as claimed in claim 6, wherein the amount of funds requested by the fund recipient is deducted from the account that is associated with the second account number on a further condition that the amount of funds requested is equal to or less than the pre-determined limit specified by the fund sender.

8. The system as claimed in claim 1, wherein the processor module is further configured to transmit, to the POS terminal, a deduction success indication upon successful deduction of the amount of funds requested by the fund recipient from the fund sender's account that is associated with the second account number.

9. The system as claimed in claim 1, wherein on a condition that the amount of funds requested by the fund recipient from the fund sender for payment is less than a price of one or more products, the processor module is further configured to:
receive the price of the products from the POS terminal;
determine an amount of funds to be deducted from the fund recipient's account that is associated with the first account number based on a difference between the price of the products and the amount of funds requested by the fund recipient; and
transmit, to the payment module, an instruction to deduct the determined amount of funds from the fund recipient's account that is associated with the first account number.

10. The system as claimed in claim 1, wherein the first and second set of characters are mobile phone numbers related to the fund recipient and fund sender respectively.

11. A method of processing payment, comprising:
receiving, at a processor module from a point-of-sale (POS) terminal:
a first set of characters that is a proxy for a first account number associated with a fund recipient's account;
a second set of characters that is a proxy for a second account number associated with a fund sender's account; and
an amount of funds requested by the fund recipient from the fund sender;
converting, by the processor module:
the first set of characters into the first account number;
the second set of characters into the second account number; and
transmitting, from the processor module to a payment module:
the first and second account numbers; and
an instruction to deduct the amount of funds requested by the fund recipient from the fund sender's account that is associated with the second account number.

12. The method as claimed in claim 11, wherein the first and second set of characters are received at the processor module in a format according to ISO 8583 data element 2.

13. The method as claimed in claim 12, wherein converting the first and second set of characters into the first and second account numbers respectively comprises:
retrieving, from a database, the first account number that is linked to the first set of characters in the database;
retrieving, from the database, the second account number that is linked to the second set of characters in the database; and
substituting the first and second set of characters with the retrieved first and second account numbers respectively, wherein the first and second account numbers are transmitted from the processor module to the payment module in the format according to ISO 8583 data element 2.

14. The method as claimed in claim 12, further comprising appending at least one digit to the first and second set of characters such that the first and second set of characters are received at the processor module in the format according to ISO 8583 data element 2.

15. The method as claimed in claim 11, wherein the instruction to deduct the amount of funds requested by the fund recipient is transmitted from the processor module to the payment module on a condition that there is a prior approval from the fund sender for deduction of funds from the account that is associated with the second account number upon a request by the fund recipient having the account that is associated with the first account number.

16. The method as claimed in claim 15, wherein the prior approval from the fund sender comprises a pre-determined limit specified by the fund sender with respect to the maximum amount of funds that can be deducted from the account that is associated with the second account number upon the request by the fund recipient having the account that is associated with the first account number.

17. The method as claimed in claim 16, wherein the amount of funds requested by the fund recipient is deducted from the account that is associated with the second account number on a further condition that the amount of funds requested is equal to or less than the pre-determined limit specified by the fund sender.

18. The method as claimed in claim 11, further comprising: transmitting, from the processor module to the POS terminal, a deduction success indication upon successful deduction of the amount of funds requested by the fund recipient from the fund sender's account that is associated with the second account number.

19. The method as claimed in claim 11, wherein on a condition that the amount of funds requested by the fund recipient from the fund sender for payment is less than a price of one or more products, the method further comprises:
receiving, at the processor module from the POS terminal, the price of the products;
determining, by the processor module, an amount of funds to be deducted from the fund recipient's account that is associated with the first account number based on a difference between the price of the products and the amount of funds requested by the fund recipient; and
transmitting, from the processor module to the payment module, an instruction to deduct the determined amount of funds from the fund recipient's account that is associated with the first account number.

20. The method as claimed in claim 11, wherein the first and second set of characters are mobile phone numbers related to the fund recipient and fund sender respectively.
